(19) United States
(12) Patent Application Publication
(10) Pub. No.: US 2003/0010434 A1
(43) Pub. Date: Jan. 16, 2003

(54) Process of making a lamellated wood product

(75) Inventor: Raoul Grenier, St-Prime (CA)

Correspondence Address: MCDERMOTT WILL & EMERY, 600 13TH STREET, N.W., WASHINGTON, DC, 20005-3096, US

(73) Assignee: Les Placements R. Grenier Inc.

(21) Appl. No.: 09/902,599

(22) Filed: Jul. 12, 2001

(51) Int. Cl. B32B 31/00

(52) U.S. Cl. 156/264

(57) ABSTRACT

A process for making a lamellated wood product is disclosed. The process has the following steps:

a) providing wood slats of generally uniform thickness;

b) edge-bonding the wood slats to form a large panel of a predetermined width;

c) cutting lengthwise the panel of step b) into a plurality of small panels of substantially identical width;

d) face-bonding a number of the small panels to form a lamellated beam having a thickness equal to the width of the small panels and a width equal to the product obtained by multiplying said number of small panels with the thickness of the same;

e) cutting lengthwise and thicknesswise the lamellated beam into a plurality of small beams having a width identical to the width of the small panels;

f) cutting lengthwise and thicknesswise the small beams into a plurality of lamellated wood product of desired dimensions.

The lamellated wood product produced thereof has superior dimensional stability and improved mechanical properties.

### FIELD OF THE INVENTION

The present invention relates generally to the field of wood. More particularly, the present invention relates to a process for making a lamellated wood product and the lamellated wood product produced thereby.

### BACKGROUND OF THE INVENTION

The field of glued laminated or lamellated wood has produced lamellated wood products that are reliable, dimensionally stable and long lasting. These lamellated wood products are known to absorb shocks that would normally break or rupture other material, such as conventional wood products.

Once, old growth forests provided most of the lumber used in the lamellated wood industry, but these old forests have now largely been cut.

Today, most of the lumber produced is from much smaller trees obtained from second growth forests and, increasingly, from northern forests or even from plantation forests. The diameter of these trees is smaller than the diameter of the trees harvested from the old forests, and consequently, the lamellated wood products produced therefrom have smaller dimensions and unfortunately, have lower grades than those produced in the past. Therefore, there is a need for methods that will provide a lamellated wood product showing improved mechanical properties.

Known in the prior art, there is U.S. Pat. No. 5,881,786 in the name of WILDERMAN ET AL. Wilderman discloses a method of making a lamellated wood product using slats from roundwood logs having end-to-end sweep.

Even though the processes of making a lamellated wood product known in the art have resulted in the advancement within the present field, there is still a need for a process of making a lamellated wood product that will provide a superior dimensional stability and improved mechanical properties than those produced by processes known to this date.

### SUMMARY OF THE INVENTION

It is therefore an object of the present invention to provide a process for making a lamellated wood product that will fulfil the above mentioned need.

In accordance with the invention, that object is achieved with a process for making a lamellated wood product comprising the steps of:

a) providing wood slats of generally uniform thickness;

b) edge-bonding the wood slats to form a large panel of a predetermined width;

c) cutting lengthwise the panel of step b) into a plurality of small panels of substantially identical width;

d) face-bonding a number of the small panels to form a lamellated beam having a thickness equal to the width of the small panels and a width equal to the product obtained by multiplying said number of small panels with the thickness of the same;

e) cutting lengthwise and thicknesswise the lamellated beam into a plurality of small beams having a width identical to the width of the small panels;

f) cutting lengthwise and thicknesswise the small beams into a plurality of lamellated wood product of desired dimensions.

The present invention also provides a process for making a lamellated wood product comprising the steps of:

a) providing wood slats of generally uniform thickness;

b) edge-bonding the wood slats to form panels of a predetermined substantially identical width;

c) face-bonding the panels to form a lamellated beam with a plurality of lamellation planes;

d) cutting the lamellated beam along an axis parallel to the lamellation planes to form small beams;

e) cutting the small beams along at least one axis perpendicular to the lamellation planes to form a lamellated wood product of desired dimensions.

The present invention also relates to a lamellated wood product obtained by any of the processes as described above.

The process according to the present invention offers a relatively simple solution for the mass production of a lamellated wood product showing excellent and uniform mechanical properties. It also allows the sawn timbers to be recycled and the production of wood chips to be reduced.

Advantageously, apart from showing excellent and uniform mechanical properties throughout the product, the final wood product obtained by a process according to the present invention shows a superior dimensional stability over those known in the art. It is believed that this is mainly due to the fact that the final wood product is obtained by cutting lenghtwise the intermediate lamellated beam formed during the process along two different axes thereby allowing a better distribution of the internal forces therein, which in turn is mainly due to the fact that the microstructure, that is to say the distribution of the fibers, of the final product is more uniform.

### BRIEF DESCRIPTION OF THE DRAWINGS

The present invention and its advantages will be more easily understood after reading the following non-restrictive description of a preferred embodiment thereof, made with reference to the following drawings wherein:

FIGS. 1A to 1I schematically represent the general steps of making a lamellated wood product according to a preferred embodiment of the invention, and wherein FIG. 1A is a perspective view of one slat; FIG. 1B is a perspective view showing the steps of edge-bonding slats of FIG. 1A to form a large panel; FIG. 1C is a perspective view showing the steps of cutting lenghtwise the large panel of FIG. 1B to form smaller panels; FIG. 1D is a perspective view of one small panel; FIG. 1E is a perspective view of a large beam obtained by face-bonding a plurality of small panels of FIG. 1D; FIG. 1F is a perspective view of the large beam of FIG. 1E after being rotated from an angle of 90°; FIG. 1G is a perspective view showing the steps of cutting lenghtwise the large beam of FIG. 1F in order to obtain small beams; FIG. 1H is a perspective view showing the steps of cutting lenghtwise one small beam to form lamellated wood products; and FIG. 1I is a perspective view of a lamellated wood product of desired dimensions.

FIGS. 2A to 2C schematically represent the step of end-jointing small lamellas of wood to form a longer slat used in the process according to a preferred embodiment of the invention, and wherein FIG. 2A is a perspective view of one lamella, FIG. 2B is a perspective view of two lamellas prior being end-jointed; and FIG. 2C is a perspective view of a slat of wood obtained by end-jointing the lamellas.

FIGS. 3A and 3B are schematic views showing the steps of edge-bonding the slats of FIG. 2C to form a large panel (FIG. 3A) and the steps of cutting lenghthwise the large panel to form smaller panels (FIG. 3B).

FIG. 4 is a schematic perspective view illustrating the step of end-jointing two panels as the one shown in FIG. 3B.

FIG. 5 is a schematic perspective view showing the step of face-bonding a plurality of panels as the one shown in FIG. 3B to obtain a large beam.

FIGS. 6A and 6B are schematic perspective views of the beam of FIG. 5 after being rotated from an angle of 90° (FIG. 6A) and showing the step of cutting lengthwise the same to obtain smaller beams (FIG. 6B).

### DESCRIPTION OF A PREFERRED EMBODIMENT

The wood product obtained with the process according to the present invention is obtained by using at first relatively small pieces of wood that are first assembled by edge-bonding and then by face-bonding to be thereafter cut lengthwise along two perpendicular axes in order to eliminate, or at least greatly reduce, the internal stresses of the final wood product and thus greatly improving the stability of the same.

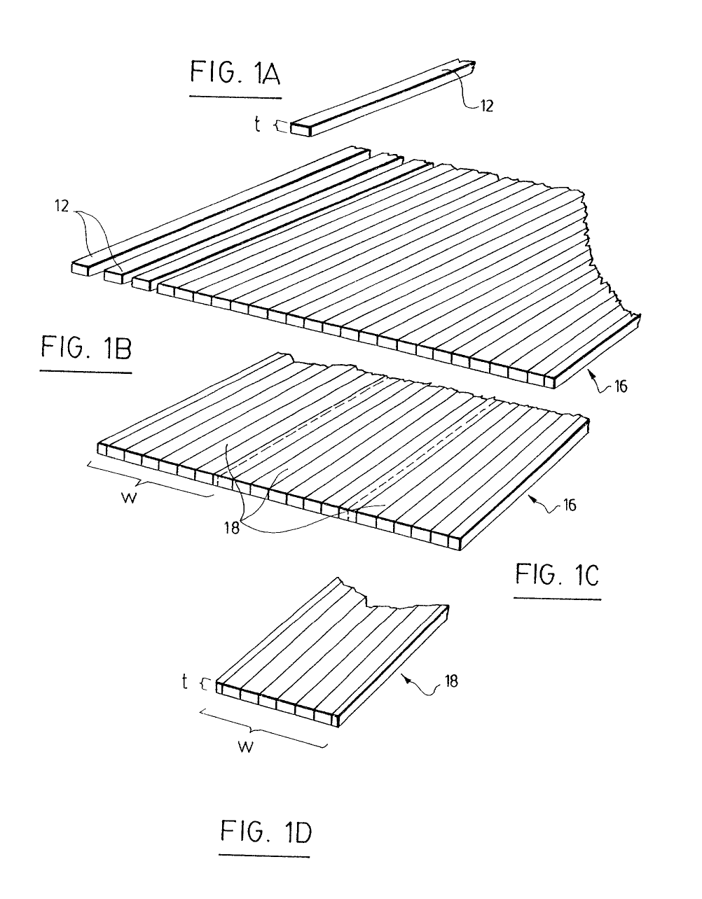

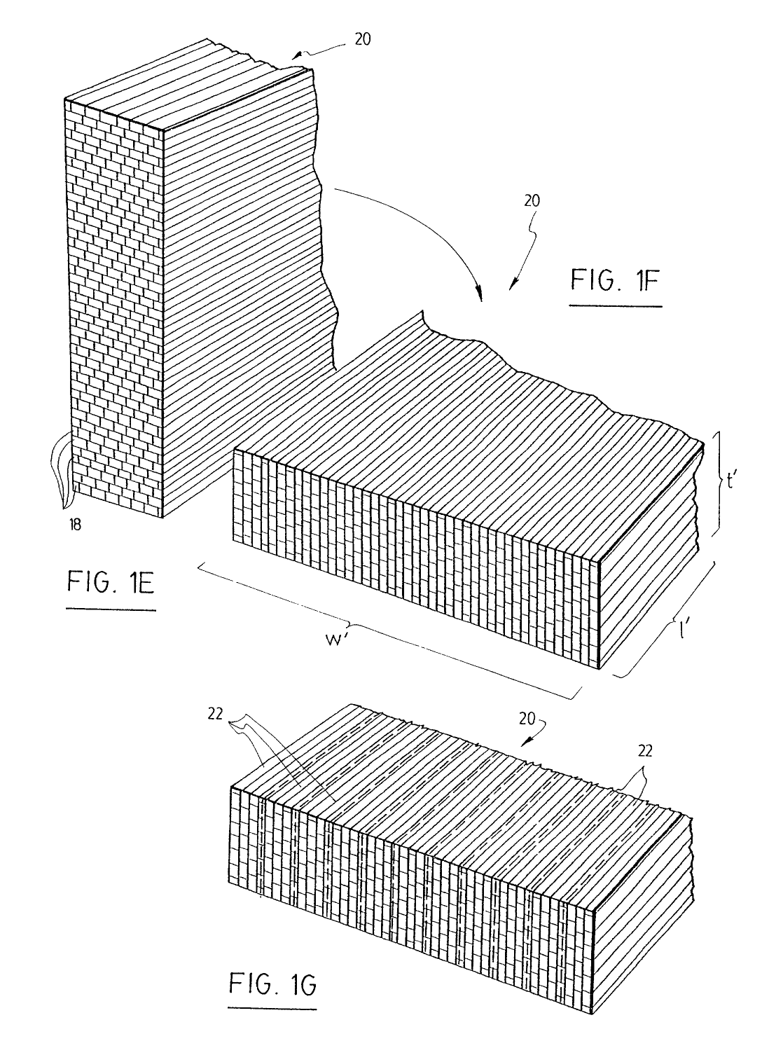

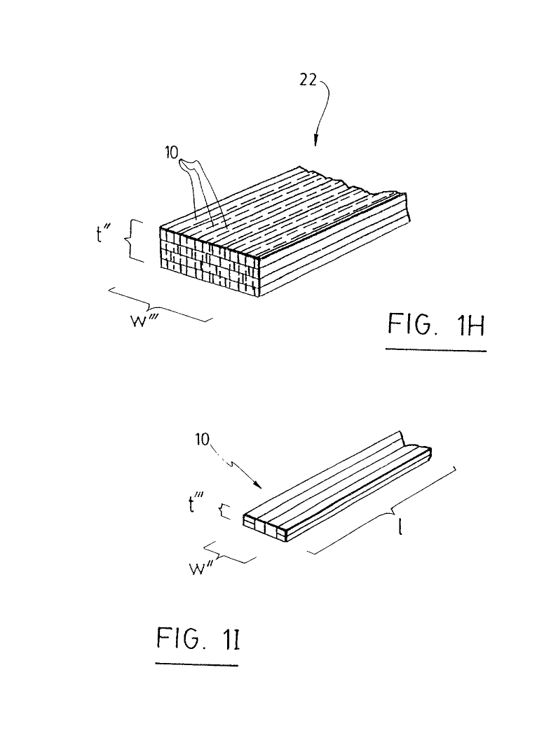

FIGS. 1 to 6 are schematically illustrating the different consecutive steps of a process for making a lamellated wood product (10) according to the present invention. Generally described the process comprises the following steps:

a) providing wood slats (12) of generally uniform thickness (t), as shown in FIG. 1A;

b) edge-bonding the wood slats (12) of step a) to form a large panel (16) of a predetermined width, as shown in FIG. 1B;

c) cutting lengthwise the large panel (16) obtained in step b) into a plurality of smaller panels (18) of substantially identical width (w), as shown in FIG. 1C where, in order not to overload the figure, only one of such smaller panel (18) is illustrated in FIG. 1D; and optionally end-jointing the panels (18) so obtained to produce longer panels, as shown in FIG. 4;

d) referring now to FIG. 1E, a given number of the small panels (18) obtained in step c) are face-bonded to form a lamellated beam (20). The lamellated beam (20) so obtained has, after having been rotated from a 90° angle and as shown in FIG. 1F, a thickness (t′) equal to the width (w) of the smaller panels (18) and a width (w′) equal to the product obtained by multiplying the number of small panels (18) used in the lamellation process with the thickness (t) of the same;

e) referring now to FIG. 1G, the lamellated beam (20) obtained in step d) is then cut lengthwise and thicknesswise to obtain a plurality of small beams (22). The dotted lines in FIG. 1G are indicating the cutting lines in the large beam (20) which will give a plurality of small beams (22);

f) referring now to FIG. 1H, the small beams (22) so obtained, before being send to the next step of the process for further treatment, are rotated from a 90° angle. In order not to overload the figure, only one of such small beams (22) is illustrated in FIG. 1H. As can be appreciated from FIG. 1H, after having been so rotated, the small beams (22) show a width (w′″) identical to the width (w) of the small panels (18) shown in FIG. 1D, and a thickness (t″) which depends on where the large beam (20) has been cut lenghtwise. Then, the small beams (22) are cut lengthwise and thicknesswise into a plurality of final lamellated wood products (10) of desired dimensions. The dotted lines shown in FIG. 1H are indicating an example of possible cutting lines in the small beam (22). As can be appreciated, the final product (10) obtained, and where only one of such final product is shown in FIG. 1I in order not to overload the figure, has a width (w″) equal to the thickness (t″) of the small beam (22) of FIG. 1H and a thickness (t′″) which depends on where the small beam (22) has been cut lenghtwise.

Each of the above generally described steps will now be described in more detail.

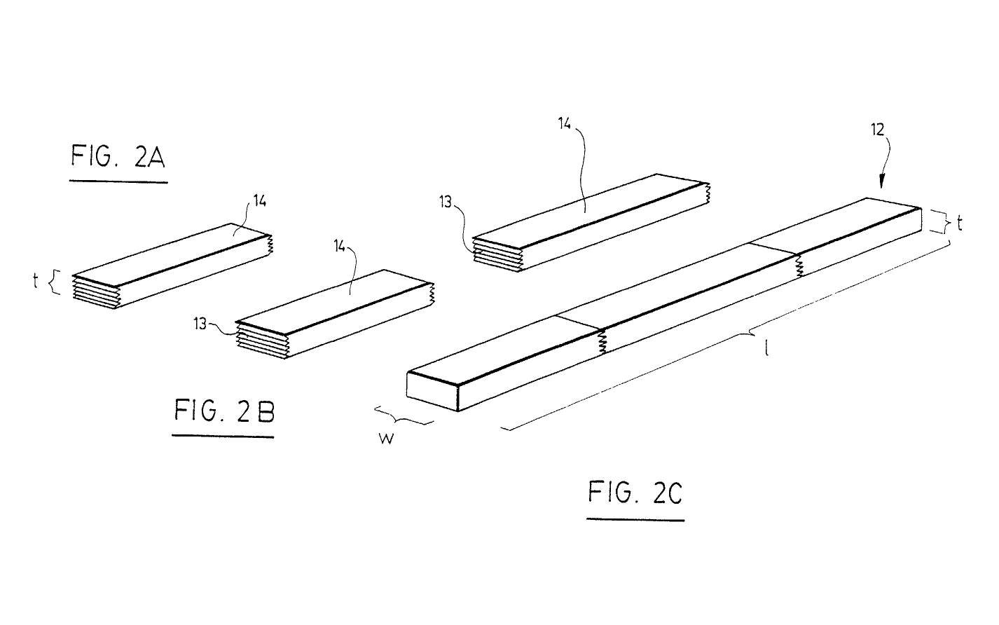

As shown in FIGS. 2A to 2C, the wood slats (12) used in the process may consist of single pieces of wood having at first the length required or expected for the final product. However, in most cases the process will preferably further comprises, prior to the above described step a), the additional steps of providing lamellas (14) of generally uniform thickness (t) and end-jointing the same to form the wood slats (12) used in step a). For example, if the wood slats (12) are long enough for the expected final product they will be used as such. On the other hand, if they do not have the required length, the wood slats (12) appropriate for the process could be easily obtained by end-jointing small lamellas of wood (14) as shown in FIGS. 2B and 2C.

As apparent for any person skilled in that art, the end-jointing of the lamellas (14) could be performed by jointing planar end surfaces of the lamellas (14) together or, as shown in FIGS. 2A and 2B, by jointing corrugated end surfaces (13) of the lamellas (14), this latter process being also called finger jointing.

Although the dimensions of the wood slats (12) suitable for the process are not limited to any particular dimension, their preferable dimension is preferably as follows: a thickness (t) varying approximately between 0.75 to 2 inches, a width (w) varying approximately between 2 to 6 inches and a length (I) preferably varying between 3 to 20 feet.

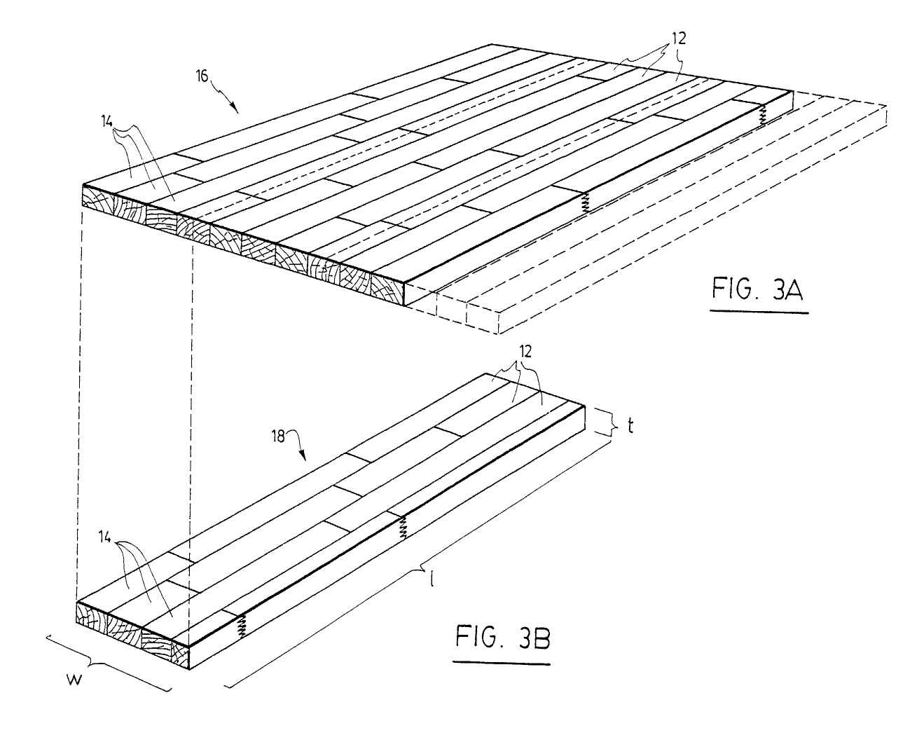

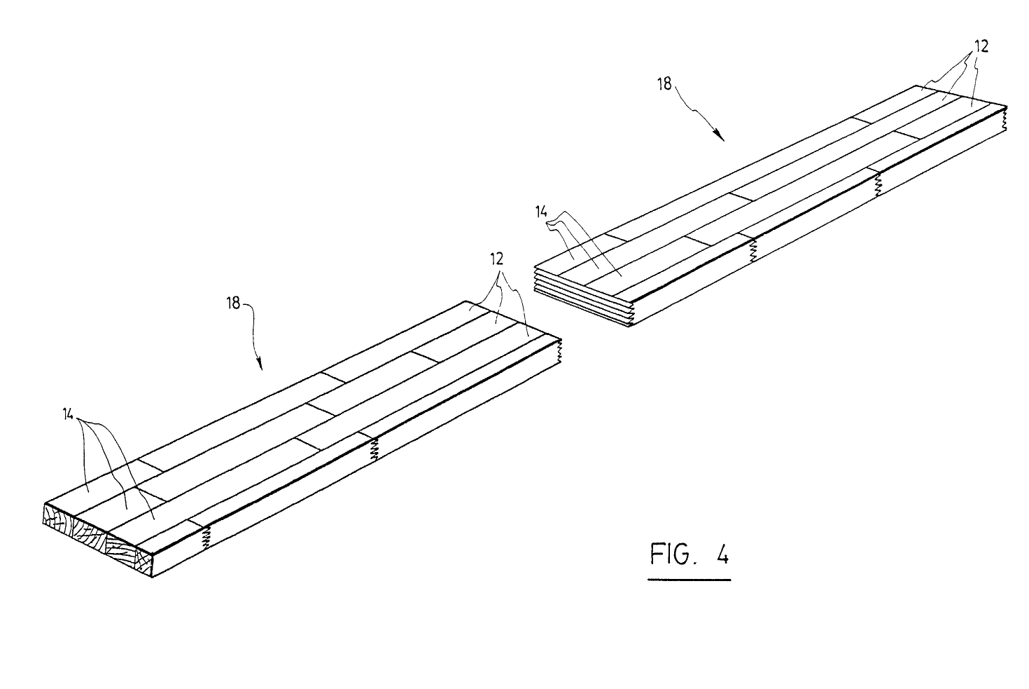

As mentioned before, the next step of the process, which is illustrated in FIG. 1B and in better details in FIG. 3A, is to edge-bond the wood slats (12) obtained in step a) in order to form a large panel (16) of predetermined width. It is worth mentioning that during the edge-bonding step, it may be advantageous to orient the wood fibers of the slats, in an “inverse-manner”, that is to say that between adjunct slats, the fibers are not disposed in the same orientation, as shown in FIG. 3A. Such a disposition of the fibers will provide a better distribution of the internal forces.

As apparent to any person skilled in that art and in order to optimise the bonding, the edges of the wood slats (12) are preferably planed off prior to bonding. Then, the large panel (16) is cut lengthwise to form a plurality of smaller panels (18) of substantially identical width (w), as shown in FIG. 3B. As can be appreciated, only one of such small panels (18) is shown in FIG. 3B. In order to optimally obtain the panels (18), the edge-bonding and cutting of step b) are preferably performed in continuous.

It is worth mentioning that according to another preferred version of the process, the small panels (18) of identical width (w) may also be obtained by simply edge-bonding a specific number of wood slats (12) so to obtain a plurality of small panels (18) of identical width. In this way, the step of cutting lengthwise a large panel at equally space apart distance so to form a plurality of small panels of identical width is omitted.

As the large panel (16) and the small panels (18) both follow from the edge-bonding of the wood slats (12) shown in FIG. 2C, their thickness (t) and length (I) are the same as the wood slats (12), that is a thickness (t) varying approximately betweeen 0.75 to 2 inches and a length (I) varying between 3 to 20 feet.

All the small panels (18) obtained in the process, either by cutting lengthwise the large panel (16) or by edge-bonding a specific number of wood slats (12) as mentioned before, have an identical width (w) which preferably varies between 4 to 16 inches. For example, for obtaining a plurality of small panels (18) of 4 inches, the large panel (16) is cut lengthwise at approximately every four inches.

It is also worth noting that in order to obtain a longer panel (18), it may be advantageous to end-joint the small panels (18) to form longer panels, preferably up to 120 feet in length, preferably by finger-jointing the smaller panels (18), as shown in FIG. 4.

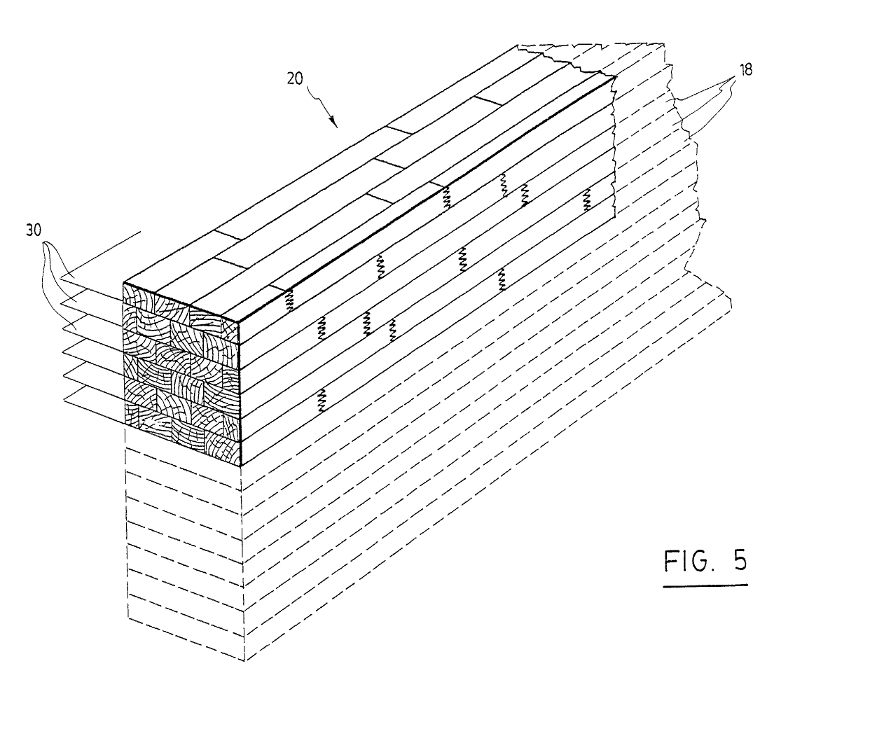

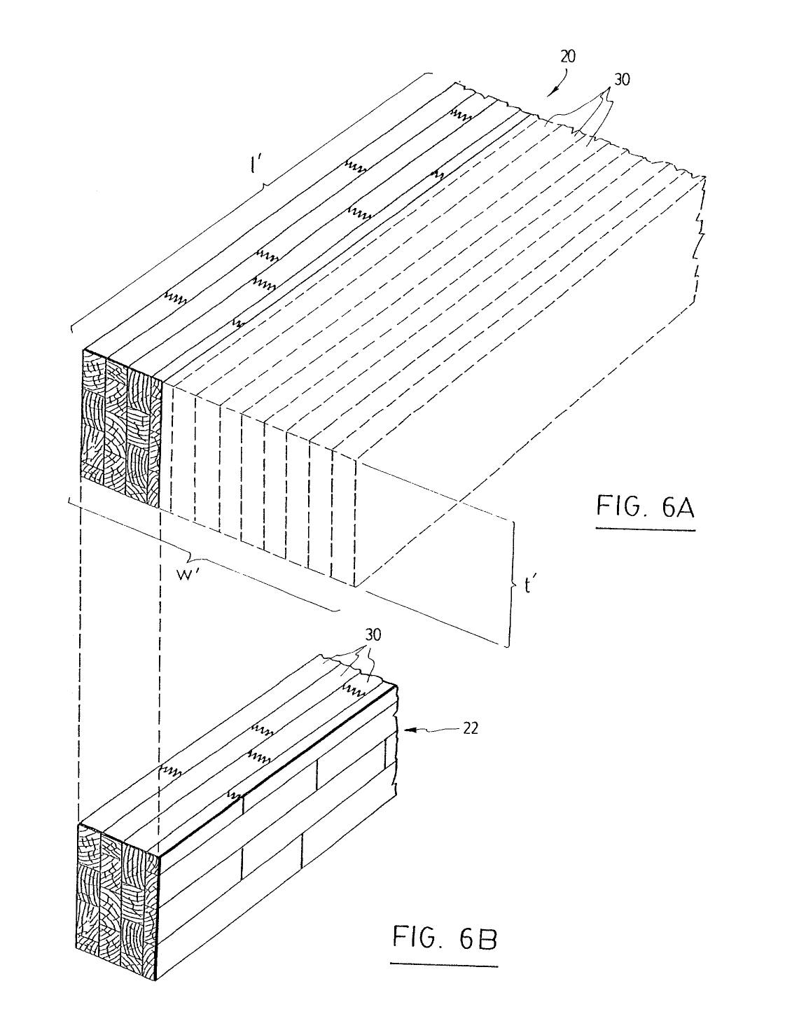

Turning now to FIG. 5, and as already explained, the smaller panels (18) obtained in step c) are subjected to a lamellation process where they are face-bonded to form a lamellated beam (20) which shows, after being rotated from an angle of 90° and as shown in FIG. 6A, a thickness (t′) equals to the width (w) of the smaller panels (18) since the lamellated beam (20) comes from the lamellation of those small panels (18) and a width (w′) equals to the number of small panel (18) used in the face-bonding multiplied by the thickness (t) of the same. In general, the width (w′) of the lamellated beam (20) varies approximately between 4 to 6 inches. And obviously, the length (I′) of the lamellated beam will be equal to the length (I) of the small panels (18) and thus preferably varies between 3 to 120 inches.

For example, if the smaller panels (18) used has a width (w) of 5 inches and a thickness (t) of one inch, and twelve of those smaller panels (18) are face-bonded to form a large beam (20), this large beam (20) will have a thickness (t′) of 5 inches and a width (w′) equals to 12 inches obtained by multiplying twelve by one inch.

Now referring back to FIGS. 6A and 6B, the lamellated beam (20) is then cut lengthwise and thicknesswise into small beams (22), only one of which is illustrated in FIG. 6B. In other words, the lamellated beam (20) is cut along an axis pararallel to the lamellation planes (30) of the beam (20). which lamellation planes (30) extend at the junction of each two bonded faces of the panels (18), as best shown in FIG. 5.

Referring back to FIG. 1H and as mentioned before, the small beams (22) after being rotated from a 90° angle all shows a width (w′″) equal to the width (w) of the small panels (18) and a thickness (t″) which is directly dependent on where the large beam (20) has been cut lengthwise.

For example, if we are taking back the above example where a large beam (20) of twelve (12) inches in width (w′) and of five (5) inches in thickness (t′) was formed, and we are cutting the same lenghtwise at each 3 inches, or in other words we are cutting the same along different axes parallel to the lamellations planes (30) of the beam (20) and spaced-apart from a 3-inch distance, the small beams (22) that will be obtained will have, after being rotated, a width (w) of five (5) inches and a thickness (t) of three (3) inches.

The small beams (22) are then cut lenghtwise and thicknesswise, as shown in FIG. 1H, to form a plurality of lamellated final products (10). In other words, the small beams (22) are cut along axes perpendicular to the lamellations planes (30) described above.

Referring back to FIG. 1I, the thickness (t′″) of the final lamellated wood product (10), which directly depends on where the small beams (22) have been cut, preferably varies between 7/16 to 16.00 inches, the width (w″), which is equal to the thickness (t″) of the small beams (22) of FIG. 1H, preferably varies between 4.00 to 60.00 inches and the length (I) preferably varies between 3.00 to 120.00 feet. As can be appreciated in FIG. 1I, such a final lamellated wood product may be a lamellated wood plank. As apparent to one skilled in the art, a lamellated wood beam or any other type of product could also be obtained by simply cutting the small beam (22) in thicker slices.

It should be understood that a wood slat (12), a large panel (16), a small panel (18), a lamellated beam (20) and a lamellated wood product (10) according to the present invention may have other dimensions than those mentioned above without departing from the scope of the present invention.

Prior to step c) of face-bonding, the faces of the panels (18) are preferably planed off. Likewise, after step e), edges and faces of the lamellated wood product (10) are preferably planed off.

It will be understood that the present invention contemplates employing lamelas (14) and slats (12) which come from a coniferous or broad-leaved tree. It may also be advantageous to provide wood slats (12) made with lamellas (14) from a coniferous tree and lamellas from a broad-leaved tree. Most preferably, the final wood product (10) is composed of a plurality of pieces of wood coming from different species of trees.

As apparent to any person skilled in the art, the glue used for the edge-bonding and face-bonding steps is any type of glue commonly used in the field. However, the chosen glue is preferably a structural wood glue and may be selected from among pure resorcinol and phenol-resorcinol-formaldehyde (PRF) or it may be a non structural wood glue selected from among polyvinyl acetate (PVA), urea melamine (UM) or urea formaldehyde.

The edge-bonding and face-bonding steps may be performed either mechanically or chemically. In the case where mechanical bonding is used, the following glue will preferably be used: phenol-resorcinol or melamine. In the case where chemical bonding is used, the following glue will preferably be used: polyurethane or isocyanate.

### EXAMPLE

The sequence of steps for making a lamellated wood product (10) according to a process of the present invention using a glue-wood assembly by mechanical or chemical bonding from the reception of the raw material to the final product may be the following:

drying of the raw material which consists of a plurality of lamellas (14) to a humidity content varying between 8 to 14% by weight;

analysis of the humidity content of the lamellas (14);

if necessary, visual analysis or scanning of the lamellas to detect any defect present in each lamellas (14);

eliminating most or all the defects detected;

profiling the end joints;

if necessary, preheating the end joints for mechanical bonding or humidifying the end joints for chemical bonding;

applying the glue on the end joints;

end jointing the lamellas (14) and pressing the joints to form a wood slat (12);

hardening of the glue joints;

planing off of the wood slats (12);

if necessary, preheating the edges of the wood slats (12) for mechanical bonding or humidifying the edges for chemical bonding;

applying the glue on the edges;

edge-bonding the wood slats (12) to form the large panel (16);

cutting the large panel (16) to form smaller panels (18);

profiling the end joints of the panels (18);

if necessary, preheating the end joints for mechanical bonding or humidifying the end joints for chemical bonding;

applying the glue on the end joints;

end jointing the panels (18) and pressing the joints to form a longer panel;

hardening of the glue joints;

planing off of the panels (18);

if necessary, preheating faces of the panels (18) for mechanical bonding or humidifying the faces for chemical bonding;

applying the glue on the faces;

face-bonding the panels (18) to form a lamellated beam (20);

hardening of the glue joints;

cutting the lamellated beam (20) along axes parallel to the lamellations planes (30) to form small beams (22);

cutting the small beams (22) along axes perpendicular to the lamellation planes (30) to form a lamellated wood product 10 of desired dimensions;

planing off and, if nesessary, treating the lamellated wood product (10);

visual, mechanical and physical control of the quality of the final product (10);

trimming ends of the final product (10) with precision;

piling and wrapping of the final product (10);

stocking the final product (10); and

shipping the final product (10) to the client.

By treating the lamellated wood product (10), it is meant to apply a product, which is preferably rubber-based or any other product known by a person skilled in the field of wood to protect the surfaces and/or the interior of the lamellated wood product against shocks, vibrations, heat and cold temperature, differences in temperature, humidity, larvae and insects, etc. . . .

Therefore, a lamellated wood product (10) according to the present invention may have many different uses. For example, it may be used as a composing element of a railroad, as a composite element of a house, a furniture or a decorative moulding, as a composing element of a wharf, as a composing element of an electric or a telephone post.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

What is claimed is:

1. Process for making a lamellated wood product, comprising the steps of:
a) providing wood slats of generally uniform thickness;
b) edge-bonding the wood slats to form a large panel of a predetermined width;
c) cutting lengthwise the panel of step b) into a plurality of small panels of substantially identical width;
d) face-bonding a number of the small panels to form a lamellated beam having a thickness equal to the width of the small panels and a width equal to the product obtained by multiplying said number of small panels with the thickness of the same;
e) cutting lengthwise and thicknesswise the lamellated beam into a plurality of small beams having a width identical to the width of the small panels;
f) cutting lengthwise and thicknesswise the small beams into a plurality of lamellated wood products of desired dimensions.

2. Process according to claim 1, wherein the wood slats are end-jointed lamellas.

3. Process according to claim 2, comprising prior to step a), a step of providing lamellas of generally uniform thickness and end-jointing the lamellas to form the wood slats of step a).

4. Process according to claim 1, wherein prior to step b), edges of the wood slats are planed off.

5. Process according to claim 1, wherein the edge-bonding of step b) and the cutting of step c) are performed in continuous.

6. Process according to claim 1, wherein prior to step c), a step of end-jointing the small panels to form longer panels.

7. Process according to claim 1, wherein prior to step d), faces of the small panels are planed off.

8. Process according to claim 1, wherein after step f), edges and faces of the lamellated wood product are planed off.

9. Process according to claim 1, wherein the wood slats come from a tree selected from the group consisting of a coniferous tree and a broad-leaved tree.

10. A lamellated wood product obtained by the process as claimed in claim 1.

11. Process for making a lamellated wood product, comprising the steps of:
a) providing wood slats of generally uniform thickness;
b) edge-bonding the wood slats to form panels of a given width;
c) face-bonding the panels to form a lamellated beam with a plurality of lamellation planes;
d) cutting the lamellated beam along an axis parallel to the lamellation planes to form small beams;
e) cutting the small beams along at least one axis perpendicular to the lamellation planes to form a lamellated wood product of desired dimensions.

12. Process according to claim 11, wherein the wood slats are end-jointed lamellas.

13. Process according to claim 12, comprising prior to step a), a step of providing lamellas of generally uniform thickness and end-jointing the lamellas to form the wood slats of step a).

14. Process according to claim 11, wherein prior to step b), edges of the wood slats are planed off.

15. Process according to claim 11, wherein in step b), the wood slats are edge-bonded then cut lengthwise to form the panels.

16. Process according to claim 15, wherein the edge-bonding and cutting of step b) are performed in continuous.

17. Process according to claim 11, wherein prior to step c), a step of end-jointing the panels to form longer panels.

18. Process according to claim 11, wherein prior to step c), faces of the panels are planed off.

19. Process according to claim 11, wherein after step e), edges and faces of the lamellated wood product are planed off.

20. Process according to claim 11, wherein the wood slats come from a tree selected from the group consisting of a coniferous tree and a broad-leaved tree.

21. A lamellated wood product obtained by the process as claimed in claim 11.

22. Process according to claim 8 or 19, wherein the lamellated wood product is treated with a rubber-based product.
